(19) United States
(12) Patent Application Publication
(10) Pub. No.: US 2022/0314152 A1
(43) Pub. Date: Oct. 6, 2022

(54) FILTER ASSEMBLY

(71) Applicant: 3M INNOVATIVE PROPERTIES COMPANY, St. Paul, MN (US)

(72) Inventors: John B. Stender, Duluth, MN (US); Matthew W. Gorrell, South St. Paul, MN (US); Christine L. McCool, St. Paul, MN (US); Chad E. Nordling, Stillwater, MN (US); Andrew R. Fox, Oakdale, MN (US); Byron E. Trotter, St. Paul, MN (US); Del R. Lawson, Cottage Grove, MN (US)

(21) Appl. No.: 17/763,942

(22) PCT Filed: Oct. 20, 2020
(86) PCT No.: PCT/IB2020/059856

§ 371 Date: Mar. 25, 2022

Related U.S. Application Data
(60) Provisional application No. 62/925,843, filed on Oct. 25, 2019.

(51) Int. Cl. B01D 46/00; F24C 15/20; B01D 46/10

(52) U.S. Cl. CPC B01D 46/0005; F24C 15/2035; B01D 46/10; B01D 2221/02; B01D 2247/06; B01D 2265/028

(57) ABSTRACT

Filter assemblies are described. In particular, a filter securement assembly for receiving and retaining a filter media in an exhaust hood is disclosed, the filter securement assembly being releasably securable to the exhaust hood, includes a filter frame, a cover and a face forming a portion of the cover, the face defining a plurality of apertures therethrough, the apertures forming at least 50% of a face surface area.

### BACKGROUND

Filters are used for many purposes, such as removing small suspended particulates from air. Filter securement assemblies may include a frame and a cover, and further can releasably retain a filter media.

### SUMMARY

In some aspects, a filter securement assembly for receiving and retaining a filter media in an exhaust hood is disclosed. The filter securement assembly can be releasably securable to the exhaust hood. The filter securement assembly can include a filter frame, a cover and a face forming a portion of the cover. The face can define a plurality of apertures therethrough, and the apertures can form at least 50% of a face surface area.

### BRIEF DESCRIPTION OF THE DRAWINGS

FIG. 1 is schematic system view of an exhaust system and cooking equipment, according to exemplary embodiments of the present disclosure.

FIG. 2 is an upper perspective view of a filter securement assembly in a first position, according to exemplary embodiments of the present disclosure.

FIG. 3 is an upper perspective view of a filter securement assembly in a second position, according to exemplary embodiments of the present disclosure.

FIG. 4 is a lower perspective view of a filter securement assembly in a first position, according to exemplary embodiments of the present disclosure.

FIG. 5 is an upper perspective view of a filter securement assembly in a first position, and further showing a retained filter media, according to exemplary embodiments of the present disclosure.

FIG. 6 is an upper perspective view of a filter securement assembly in a second position, further showing a filter media, according to exemplary embodiments of the present disclosure.

FIG. 7 is a lower perspective view of a filter securement assembly in a first position, and further showing a retained filter media, according to exemplary embodiments of the present disclosure.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Filter securement assemblies can be used in a wide range of applications. In some embodiments, filter securement assemblies may be designed for general air filtration to filter primarily airborne particulates. For example, filter media within a filter securement assembly may be designed to filter particles smaller than 10 micrometers in diameter, smaller than 5 micrometers in diameter, smaller than 2.5 micrometers in diameter, smaller than 1.0 micrometer in diameter, smaller than 0.5 micrometers in diameter or smaller than 0.3 micrometers in diameter, among others.

Filter securement assemblies can also be used to secure filter media in a specific location, such as an exhaust hood. Such filter securement assemblies may be used for a specialized purpose, such as for grease filtering in a commercial cooking environment. In commercial kitchens, grease capture in exhaust hoods may be important for health, safety and environmental reasons. However, grease buildup in and around an exhaust hood or an exhaust system may pose a fire hazard. To mitigate the hazard, commercial kitchens typically use airflow interrupters or disrupters, such as baffles, made of a non-flammable material, such as a metal or metal alloy, including stainless steel, galvanized steel or aluminum. The baffle prevents fire from spreading between the cooking surface and the exhaust system. Additionally, aerosolized grease can travel through the complicated path created by the baffle and condense on the surfaces, resulting in grease accumulating further up in the ducts. However, this grease buildup on the baffle requires regular cleaning to maintain the baffle's effectiveness as a fire barrier and a grease collector. Aesthetically, visible grease on a commercial hood baffle can also be undesirable. Removing, cleaning, and reinstalling the baffles can be time consuming, labor-intensive, expensive and dangerous. Thus, versus conventional baffles, the present disclosure can provide a grease-trapping solution that reduces or prevents the buildup of grease on exhaust system components, is light and easy to install in an exhaust hood and can be disassembled and washed in a dishwasher.

The present disclosure provides a filter securement assembly for receiving and retaining a filter media in an exhaust hood for the filtration of grease droplets. Such a filter securement assembly can be designed to replace traditional baffles in an exhaust hood, thereby requiring minimal or no modifications to existing exhaust systems. Further, the filter media received and secured by the filter securement assembly can prevent flames from passing through the filter securement assembly and prevent the buildup of grease on portions of the exhaust system 54 downstream of the filter media 163. For clarity, moving from the cooking equipment 50 through the exhaust system 54 and past the blower 66 and towards the flow represented by arrow 74 can be defined as moving downstream, while moving in the opposite direction can be defined as moving upstream. The filter securement assembly can also be easily removed for easy replacement or cleaning of the filter media. Other benefits and uses are also foreseen.

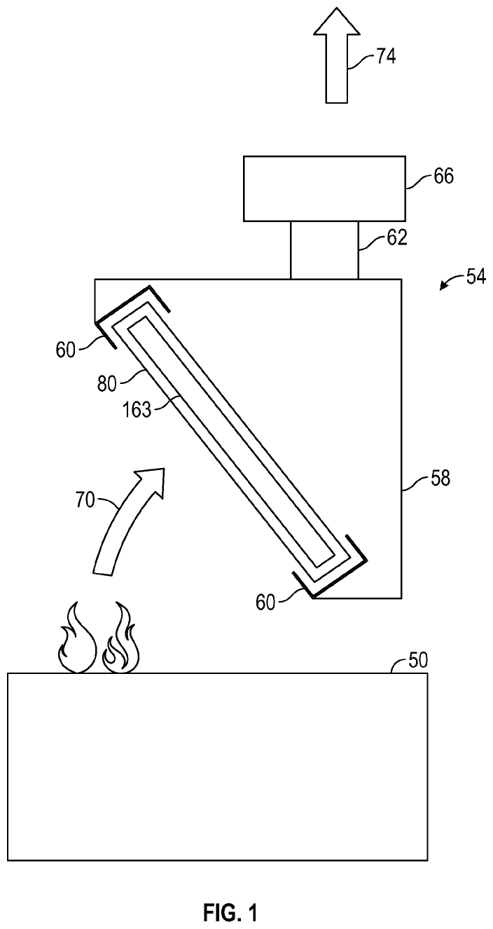

FIG. 1 is a schematic sectional view of cooking equipment 50 and an exhaust system 54. The cooking equipment 50 can be an oven, stove, grill, fryer, broiler or any other commonly used cooking apparatus known to those skilled in the art. The exhaust system 54 can include an exhaust hood 58 defining an exhaust hood flange 60. The exhaust hood 58 can be positioned to capture all or a portion of grease and other particulates generated by the use of the cooking equipment 50. A blower 66 can, via a duct 62, create a reduced-pressure area proximate the cooking equipment 50 (relative to ambient pressure) that can encourage grease and other particulates generated by use of the cooking equipment 50 to enter the exhaust system 54 via the exhaust hood 58. In such a system, as illustrated in FIG. 1, air, gasses, grease and/or particulates can travel into the exhaust system 54 via the exhaust hood 58 (and filter securement assembly 80 and filter media 163, as will be described below), as represented by arrow 70. The filtered air, gasses and any remaining grease and/or particulates can then pass through the duct 62 and blower 66 before being exiting the exhaust system 54, as represented by arrow 74. It is to be understood that filter securement assemblies 80 and filter media 163 releasably mounted on, proximate, adjacent and/or in contact with the exhaust hood flange 60 or exhaust hood 58 are within the scope of this disclosure.

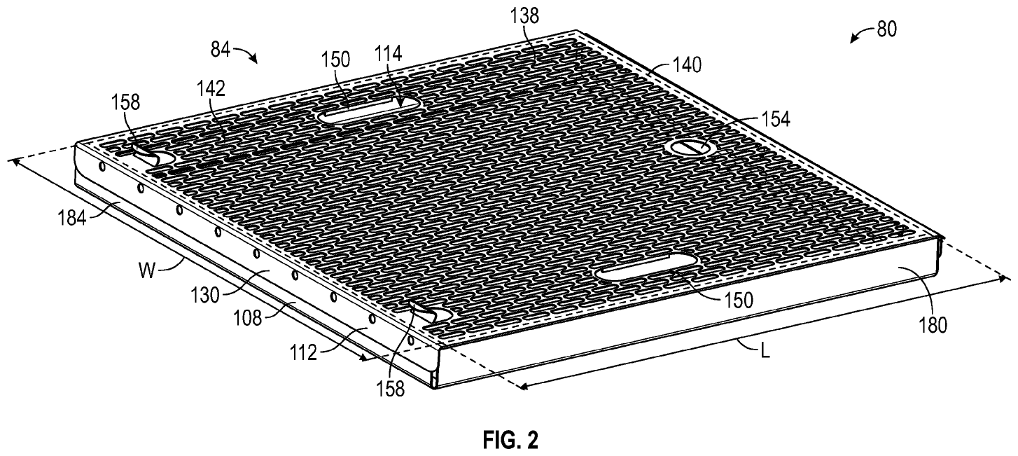

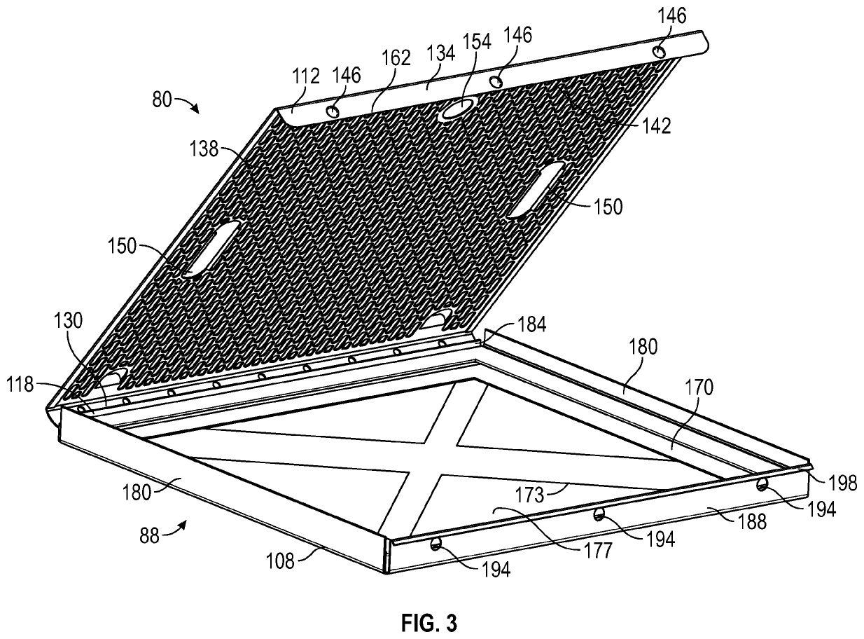

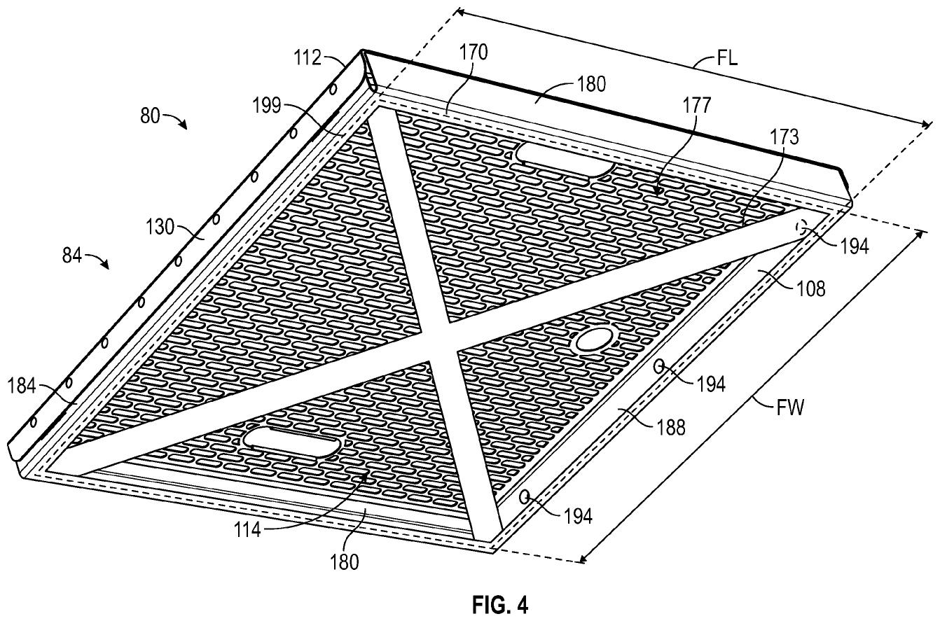

FIGS. 2-4 illustrate an exemplary filter securement assembly 80. The filter securement assembly 80 can include a filter frame 108 and a cover 112. The filter frame 108 and cover 112 can be permanently secured to one another, releasably secured to one another or not secured to one another. In some embodiments, the filter frame 108 and cover 112 are movably attached to one another such that the filter frame 108 can selectively move relative to the cover 112. In a non-limiting example, the filter frame 108 and cover 112 are hingedly attached to one another via a hinge 118. The hinge 118 can be formed on, or include, portions of the frame 108 and cover 112. In some embodiments, the hinge 118 facilitates the relative rotation of the cover 112 and filter frame 108 about the hinge 118 such that the filter securement assembly 80 can be alternatively disposed in a first position 84, as exemplarily illustrated in FIGS. 2 and 4, and a second position 88, as exemplarily illustrated in FIG. 3. These positions 84, 88 will be described below in further detail. Other filter frame 108 and cover 112 relative interactions are within the scope of this disclosure, such as the cover 112 and filter frame 108 being selectively joined in a manner similar to that shown in the first position 84 via mechanical fasteners, magnets, adhesives, hook-and-loop panels or any other releasable securement technology known to those skilled in the art.

The cover 112 can include a cover attachment surface 130, a cover securement surface 134 and a face 138. The face 138 can define one or more apertures 142 therethrough. In some embodiments, the face 138 can be substantially rectangular or substantially square. The face 138 can define a length L and a width W, a product thereof resulting in a face surface area 140. In some embodiments, the apertures 142 can define a portion of the face surface area 140. In various embodiments, the apertures 142 define, or form, 15%, 20%, 25%, 30%, 35%, 40%, 45%, 50%, 55%, 60%, 65%, 70%, 75%, 80%, 85%, 90% or 95% of the face surface area 140. In various embodiments, the apertures 142 define, or form, at least 15%, 20%, 25%, 30%, 35%, 40%, 45%, 50%, 55%, 60%, 65%, 70%, 75%, 80%, 85%, 90% or 95% of the face surface area 140. The apertures 142 can have any shape. In non-limiting embodiments, at least some of the apertures 142 can be substantially circular, ovular, triangular, rectangular, pentagonal, hexagonal, heptagonal, octagonal, organic, geometric, semi-circular, crescent-like, parallelogrammatic, quadrilateral, rhomboid and/or stadium-like. Further, in some embodiments the apertures 142 define substantially the same shape while in other embodiments the apertures 142 define two or more different shapes.

As mentioned above, the cover 112 can include a cover attachment surface 130. In some embodiments, the cover attachment surface 130 is disposed at an angle to the face 138. In some embodiments, the cover attachment surface 130 is disposed at an obtuse angle to the face 138. In some embodiments, the cover attachment surface 130 is disposed at an acute angle to the face 138. In some embodiments, the cover attachment surface 130 is disposed at a substantially right angle to the face 138. The cover attachment surface 130 can define or mount a portion of the hinge 118, through which the cover 112 can hingedly attach to the filter frame 108.

As mentioned above, the cover 112 can include a cover securement surface 134. In some embodiments, the cover securement surface 134 is disposed at an angle to the face 138. In some embodiments, the cover securement surface 134 is disposed at an obtuse angle to the face 138. In some embodiments, the cover securement surface 134 is disposed at an acute angle to the face 138. In some embodiments, the cover securement surface 134 is disposed at a substantially right angle to the face 138. In yet further embodiments, the cover securement surface 134 is disposed substantially in parallel with the cover attachment surface 130. The cover securement surface 134 can also include one or more cover securement features 146, which will be described below in conjunction with the frame securement features 194.

The cover 112 can include one or more hand holds 150. The hand holds 150 can be disposed on the face 138. The hand holds 150 can facilitate manual handling and lifting of the cover 112 and/or the filter securement assembly 80. In some embodiments, the hand holds 150 facilitate the placement of the cover 112 and/or the filter securement assembly 80 into the exhaust hood 58 and/or the exhaust hood flange 60. In some embodiments, the hand holds 150 define apertures through the face 138. However, in some embodiments, the hand holds 150 can include members that protrude from the face 138. The hand holds 150 can have any shape. In non-limiting embodiments, at least some of the hand holds 150 can be substantially circular, ovular, triangular, rectangular, pentagonal, hexagonal, heptagonal, octagonal, organic, geometric, semi-circular, crescent-like, parallelogrammatic, quadrilateral, rhomboid and/or stadium-like. Further, in some embodiments the hand holds 150 define substantially the same shape while in other embodiments the hand holds 150 define two or more different shapes.

The cover 112 can also include one or more tool receivers 154. Similar to the hand holds 150, the tool receiver 154 can facilitate handling and lifting of the cover 112 and/or the filter securement assembly 80. In some embodiments, the tool receiver 154 can facilitate the placement of the cover 112 and/or the filter securement assembly 80 into the exhaust hood 58 and/or the exhaust hood flange 60. In some embodiments, the tool receiver 154 defines apertures through the face 138. However, in some embodiments, the tool receiver 154 can include members that protrude from the face 138. The tool receiver 154 can have any shape. In non-limiting embodiments, at least some of the tool receiver 154 can be substantially circular, ovular, triangular, rectangular, pentagonal, hexagonal, heptagonal, octagonal, organic, geometric, semi-circular, crescent-like, parallelogrammatic, quadrilateral, rhomboid and/or stadium-like. The tool receiver 154 can be designed or shaped to receive a tool such as a rod, broomstick or any other manually-manipulable tool.

In some embodiments, the cover 112 includes one or more cover attachment features 158. The cover attachment features 158 can secure, releasably secure or permanently secure the cover 112 and/or filter securement assembly 80 to the exhaust hood 58 and/or exhaust hood flange 60.

The cover attachment features 158 can include hooks, magnets, adhesives, protrusions, recesses, mechanical fasteners, hook-and-loop panels or any other releasable securement technology known to those skilled in the art. In some embodiments, the cover attachment features 158 are formed by bending cut portions of the cover 112, in particular the face 138. Further, the cover attachment features 158 could, when engaged with portions of the exhaust hood 58 and/or exhaust hood flange 60, enter a mechanically-biased engagement with the exhaust hood 58 and/or exhaust hood flange 60 to more securely engage therewith.

The cover 112 can also include a cover grip 162. The cover grip 162 can provide a gripping surface or element to a user for altering the filter securement assembly 80 between the first position 84 and second position 88. The cover grip 162 will be described below in conjunction with the frame grip 198.

The filter securement assembly 80 can include a filter frame 108 in addition to the cover 112. The filter frame 108 can include a frame face 170. The frame face 170 can be substantially parallel to the cover face 138 when the filter securement assembly 80 is disposed in the first position 84. The frame face 170 can define one or more frame apertures 177 therethrough. Further, one or more frame supports 173 can pass from one portion of the frame face 170 to another to add structural support to the filter frame 108 and can also define the frame apertures 177.

In some embodiments, similar to the face 138 and face surface area 140, the frame face 170 can be substantially rectangular or substantially square. The frame face 170 can define a length FL and a width FW, a product thereof resulting in a frame face surface area 199. In some embodiments, the frame apertures 177 can define a portion of the frame face surface area 199. In various embodiments, the frame apertures 177 define, or form, 5%, 10%, 15%, 20%, 25%, 30%, 35%, 40%, 45%, 50%, 55%, 60%, 65%, 70%, 75%, 80%, 85%, 90% or 95% of the frame face surface area 199. In various embodiments, the frame apertures 177 define, or form, at least 5%, 10%, 15%, 20%, 25%, 30%, 35%, 40%, 45%, 50%, 55%, 60%, 65%, 70%, 75%, 80%, 85%, 90% or 95% of the frame face surface area 199. The frame apertures 177 can have any shape. In non-limiting embodiments, at least some of the frame apertures 177 can be substantially circular, ovular, triangular, rectangular, pentagonal, hexagonal, heptagonal, octagonal, organic, geometric, semi-circular, crescent-like, parallelogrammatic, quadrilateral, rhomboid and/or stadium-like. Further, in some embodiments the frame apertures 177 define substantially the same shape while in other embodiments the frame apertures 177 define two or more different shapes.

In some embodiments the filter frame 108 includes one or more lateral surfaces 180. The lateral surfaces 180 can be disposed at an angle to the frame face 170. In some embodiments, the lateral surfaces 180 are disposed at an obtuse angle to the frame face 170. In some embodiments, the lateral surfaces 180 are disposed at an acute angle to the frame face 170. In some embodiments, the lateral surfaces 180 are disposed at a substantially right angle to the frame face 170.

The filter frame 108 can also include a frame attachment surface 184. The frame attachment surface 184 can define or mount a portion of the hinge 118, through which the cover 112 can hingedly attach to the filter frame 108. In some embodiments, the frame attachment surface 184 is substantially perpendicular to one or more of the lateral surfaces 180 and frame face 170. Similar to the cover attachment surface 130, the frame attachment surface 184 can be disposed at an angle to the frame face 170. In some embodiments, the frame attachment surface 184 is disposed at an obtuse angle to the frame face 170. In some embodiments, the frame attachment surface 184 is disposed at an acute angle to the frame face 170. In some embodiments, the frame attachment surface 184 is disposed at a substantially right angle to the frame face 170.

In some embodiments, the filter frame 108 includes a frame securement surface 188. The frame securement surface 188 can include or mount one or more frame securement features 194. The frame securement features 194 can interact with the cover securement features 146 to releasably secure the cover 112 to the filter frame 108 when the filter securement assembly 80 is disposed in the first position 84. In some embodiments, the frame securement features 194 include dimples sized and shaped to engage with corresponding cover securement features 146, which can also be dimples or other shapes, to releasably secure the cover 112 to the filter frame 108 when the filter securement assembly 80 is disposed in the first position 84. In some embodiments, the frame securement features 194 form an interference fit with the corresponding cover securement features 146 to releasably secure the cover 112 to the filter frame 108 when the filter securement assembly 80 is disposed in the first position 84. In various embodiments, the frame securement features 194 can include one or more of hooks, magnets, adhesives, protrusions, recesses, mechanical fasteners, hook-and-loop panels or any other releasable securement technology known to those skilled in the art that engage with the cover attachment features 158, or other portions of the cover 112, to releasably secure the cover 112 to the filter frame 108 when the filter securement assembly 80 is disposed in the first position 84.

Similar to the cover securement surface 134, the frame securement surface 188 can be disposed at an angle to the frame face 170. In some embodiments, the frame securement surface 188 is disposed at an obtuse angle to the frame face 170. In some embodiments, the frame securement surface 188 is disposed at an acute angle to the frame face 170. In some embodiments, the frame securement surface 188 is disposed at a substantially right angle to the frame face 170. Further, the frame securement surface 188 can be substantially parallel to the cover securement surface 134 when the filter securement assembly 80 is disposed in the first position 84.

The frame securement surface 188 can be substantially parallel to the frame attachment surface 184. In some embodiments, the frame securement surface 188 and the frame attachment surface 184 are disposed on substantially opposed sides of the filter frame 108.

The filter frame 108 can also include a frame grip 198. The frame grip 198 can provide a gripping surface or element to a user for altering the filter securement assembly 80 between the first position 84 and second position 88.

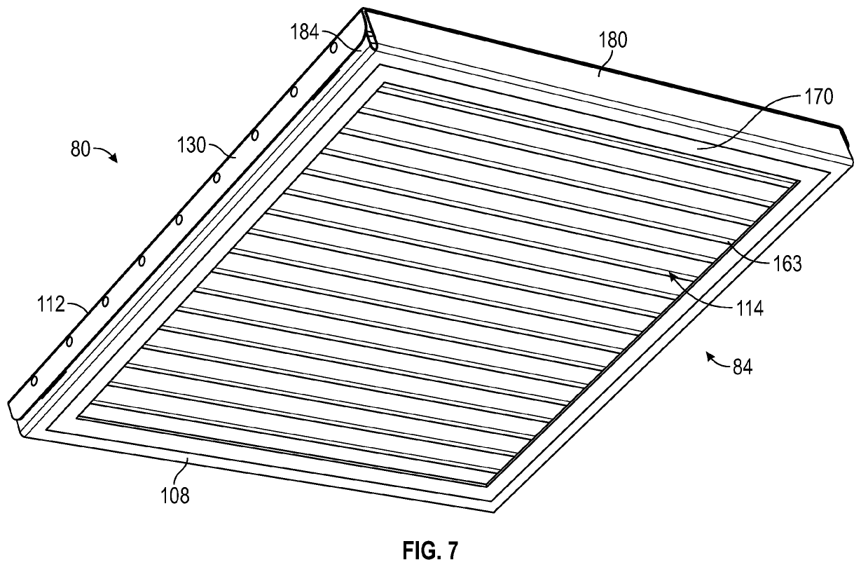

The cavity 114, as can be exemplarily seen in FIGS. 2, 4, 5 and 7, can be defined as an interior portion of the filter securement assembly 80 bounded by various surfaces when the filter securement assembly 80 is disposed in the first position 84. In particular, the cavity 114 can be bounded by one or more of the cover 112, cover attachment surface 130, cover securement surface 134, face 138, filter frame 108, frame face 170, frame support 173, frame attachment surface 184 and frame securement surface 188. The cavity 114 can be sized to receive a filter media 163, and the filter media 163 can be bounded by one or more of the aforementioned surfaces when disposed in the cavity 114.

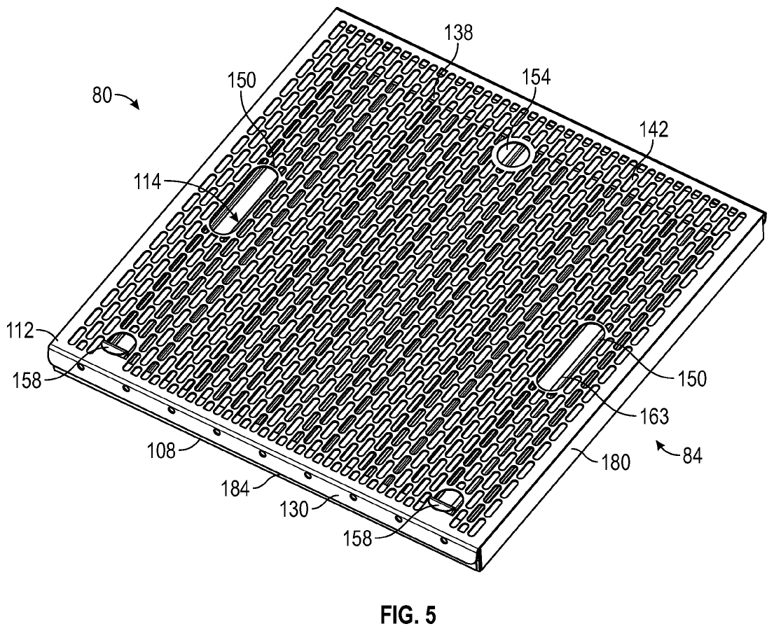

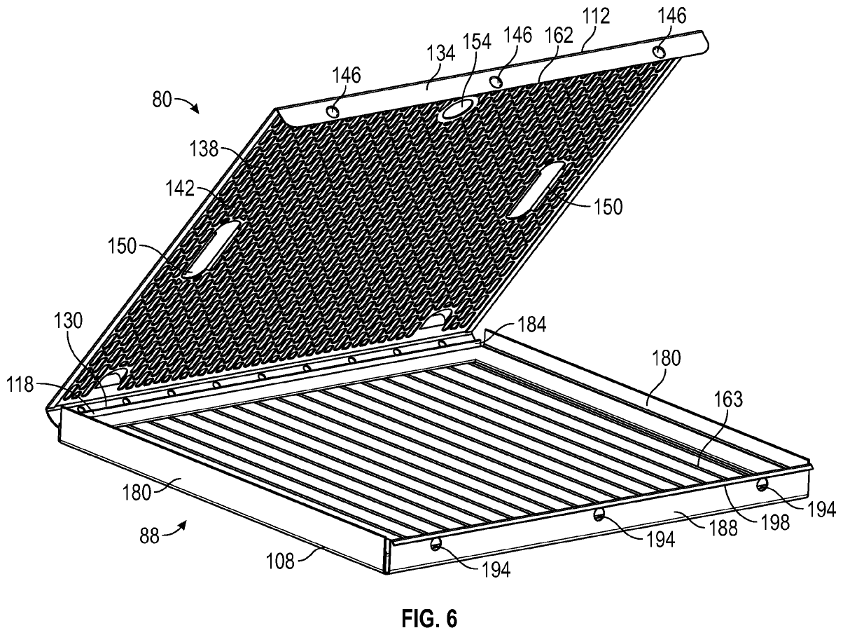

The filter media 163, as can be seen in FIGS. 5-7, can include any one or more materials or mechanical filter arrangements known to those skilled in the art. In particular, the filter media 163 can include any one or more of a Flame-Resistant (FR) media web, a woven material, a non-woven material, oxidized polyacrylonitrile (OPAN), FR rayon, modacrylic, basalt, fiberglass, wool and ceramic. In some embodiments, the filter media 163 includes a conventional filter media material (such as polyolefin) that has been treated or coated to be flame-resistant. In some embodiments, the filter media 163 includes a conventional filter media material and a metal mesh and/or a flame-resistant barrier. In various embodiments, the filter media 163 can be pleated, non-pleated and/or multilayered, based upon application.

The cover 112 and/or filter frame 108 can include one or more of a metal, metal alloy, fiberglass, ceramic, composite material, carbon composite material, stone, plastic, wood-based product, a Flame-Resistant (FR) material, a material treated and/or coated with an FR material or any other suitable material known to those skilled in the art.

In operation, the filter securement assembly 80 can be disposed in the first position 84. A user, tool and/or a machine can use the cover grip 162 and frame grip 198 to pivot the cover 112 relative to the filter frame 108, via the hinge 118, to thereby transition the filter securement assembly 80 from the first position 84 to the second position 88. The filter media 163 can then be inserted into the filter frame 108 and/or cover 112.

The filter securement assembly 80 can then be transitioned to the first position 84, where the filter media 163 can be disposed within the cavity 114 by pivoting the cover 112 relative to the filter frame 108, via the hinge 118, by the user, tool and/or machine. The cover securement feature 146 and/or the frame securement feature 194 can releasably secure the filter securement assembly 80 in the first position 84. The filter securement assembly 80 can then be placed in and/or mounted to the exhaust hood 58 or the exhaust hood flange 60 via the tool receiver 154, hand holds 150 or another portion of the filter securement assembly 80. In particular, the filter securement assembly 80 can be releasably secured to the exhaust hood 58 and/or the exhaust hood flange 60 via the cover attachment feature 158. When the user desires to remove or replace the filter media 163, the user can remove the filter securement assembly 80 from the exhaust hood 58 or the exhaust hood flange 60 using the tool receiver 154, hand holds 150 or another portion of the filter securement assembly 80. Once removed from the exhaust hood 58 or exhaust hood flange 60, the user, tool and/or machine can use the cover grip 162 and frame grip 198 to pivot the cover 112 relative to the filter frame 108, via the hinge 118, to transition the filter securement assembly 80 from the first position 84 to the second position 88 and remove the filter media 163 from the filter securement assembly 80.

Additionally, one or more of the cover 112, filter frame 108 and filter media 163 can include markings and/or indicators to indicate to a user that the filter media 163 has been properly installed in the filter securement assembly 80.

In various embodiments, the cover 112 weighs less than 0.5 pounds, 1.0 pounds, 1.5 pounds, 2.0 pounds, 2.5 pounds, 3.0 pounds, 3.5 pounds, 4.0 pounds, 4.5 pounds, 5.0 pounds, 5.5 pounds, 6.0 pounds, 6.5 pounds, 7.0 pounds, 7.5 pounds or 8.0 pounds. In various embodiments, the filter frame 108 weighs less than 0.5 pounds, 1.0 pounds, 1.5 pounds, 2.0 pounds, 2.5 pounds, 3.0 pounds, 3.5 pounds, 4.0 pounds, 4.5 pounds, 5.0 pounds, 5.5 pounds, 6.0 pounds, 6.5 pounds, 7.0 pounds, 7.5 pounds or 8.0 pounds. In various embodiments, the filter securement assembly weighs less than 0.5 pounds, 1.0 pounds, 1.5 pounds, 2.0 pounds, 2.5 pounds, 3.0 pounds, 3.5 pounds, 4.0 pounds, 4.5 pounds, 5.0 pounds, 5.5 pounds, 6.0 pounds, 6.5 pounds, 7.0 pounds, 7.5 pounds, 8.0 pounds, 8.5 pounds, 9.0 pounds, 9.5 pounds or 10.0 pounds. In various embodiments, the filter securement assembly weighs about 0.5 pounds, 1.0 pounds, 1.5 pounds, 2.0 pounds, 2.5 pounds, 3.0 pounds, 3.5 pounds, 4.0 pounds, 4.5 pounds, 5.0 pounds, 5.5 pounds, 6.0 pounds, 6.5 pounds, 7.0 pounds, 7.5 pounds, 8.0 pounds, 8.5 pounds, 9.0 pounds, 9.5 pounds or 10.0 pounds.

Certain embodiments of cover 112 and/or filter frame 108 shapes, particularly those defined by the face 138, apertures 142, frame face 170, frame support 173 and/or frame apertures 177, are disclosed in U.S. Design Appl. No. 29/629,926, filed 18 Dec. 2017, U.S. Design Appl. No. 29/630,262, filed 20 Dec. 2017, U.S. Design Appl. No. 29/630,249, filed 20 Dec. 2017, U.S. Design Appl. No. 29/662,774, issued on 18 Feb. 2020, as Pat. No. D875,910, filed 7 Sep. 2018 and U.S. Design Appl. No. 29/662,776, filed 7 Sep. 2018, issued on 10 Mar. 2020, as Pat. No. D877,876.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure. The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control.

What is claimed is:

1. A filter securement assembly for receiving and retaining a filter media in an exhaust hood, the filter securement assembly being releasably securable to the exhaust hood, comprising:
a filter frame;
a cover; and
a face forming a portion of the cover, the face defining a plurality of apertures therethrough, the apertures forming at least 50% of a face surface area.

2. The filter securement assembly of claim 1, wherein the filter frame is hingedly attached to the cover.

3. The filter securement assembly of claim 1, wherein the face defines an overall length and an overall width, and where the face surface area is derived as a product of the overall length and the overall width.

4. The filter securement assembly of claim 1, wherein the cover includes a cover securement feature and the filter frame includes a frame securement feature, and where the cover securement feature engages with the frame securement feature to at least partially secure the cover to the filter frame when the filter securement assembly is in a closed position.

5. The filter securement assembly of claim 4, wherein the cover securement feature and the frame securement feature include mating dimples.

6. The filter securement assembly of claim 1, wherein the cover includes at least one cover attachment feature for releasably securing the filter securement assembly to a portion of the exhaust hood.

7. The filter securement assembly of claim 1, wherein the filter securement assembly defines a cavity when the filter securement assembly is in a closed position, and the filter media is retained and secured in the cavity.

8. The filter securement assembly of claim 1, wherein the apertures form at least 60% of the face surface area.

9. The filter securement assembly of claim 1, wherein the apertures form at least 70% of the face surface area.

10. The filter securement assembly of claim 1, wherein the apertures form at least 80% of the face surface area.

11. The filter securement assembly of claim 1, wherein the apertures form at least 90% of the face surface area.

12. The filter securement assembly of claim 1, wherein the cover includes a cover grip and the filter frame includes a filter frame grip.

13. The filter securement assembly of claim 1, wherein one or both of the cover and filter frame include stainless steel.

14. The filter securement assembly of claim 1, wherein one or both of the cover and filter frame include aluminum.

15. The filter securement assembly of claim 1, where one or both of the cover and filter frame include a flame-resistant material.

16. The filter securement assembly of claim 1, wherein the filter securement assembly is at least partially disposed within the exhaust hood.
